(19) United States
(12) Patent Application Publication
(10) Pub. No.: US 2001/0035073 A1
(43) Pub. Date: Nov. 1, 2001

(54) Spring loaded drive gun

(76) Inventors: Michael Janusz, Elgin, IL (US); David C. Goss, Rockford, IL (US)

Correspondence Address: TREXLER, BUSHNELL, GIANGIORGI,, BLACKSTONE & MARR, LTD., SUITE 3600, 105 W. ADAMS, CHICAGO, IL, 60603, US

(21) Appl. No.: 09/815,809

(22) Filed: Mar. 23, 2001

Related U.S. Application Data
(60) Provisional application No. 60/192,866, filed on Mar. 29, 2000.

(51) Int. Cl. B25B 23/02

(52) U.S. Cl. 81/57.37

(57) ABSTRACT

A drive tool which does not require any upper-body force from an operator to install a fastener. The drive tool includes a top portion which is engageable with a drive source and a lower portion which is engageable with a fastener. The drive tool includes springs which are configured to urge the lower portion and upper portion of the tool away from each other (i.e. relative movement) and provide that a generally axial force is applied to the fastener engaged with the lower portion of the tool. As a result, the operator does not need to apply any upper-body axial force to the drive tool to install the fastener. Preferably, the lower portion of the drive tool includes one or more foot pads on which an operator may stand, and the spring(s) become compressed when the operator stands on the foot pad(s). As a result of the spring(s) trying to expand, a generally axial force is applied to the fastener engaged with the lower portion of the tool, thereby reducing the amount of upper-body axial force an operator must apply to the drive tool to install the fastener. Hence, the operator can use his or her own body weight to apply an axial load during a drilling operation, and need not use any upper-body force.

### BACKGROUND

The present invention relates generally to drive tools for installing fasteners, and relates more specifically to a drive tool which does not require any upper-body force from an operator to install a fastener.

Typically (and definitely with regard to self-drilling, self-tapping fasteners), when an operator uses a drive tool, such as a drill, to drive a fastener into a work piece, the operator must use his upper-body strength to apply an axial force to the drive tool. It is advantageous to reduce the amount of upper-body strength an operator must apply to a drive tool to effect the installation of a fastener because doing so reduces the fatigue and physical stress experienced by the operator. This is especially true because oftentimes a large number of fasteners must be installed to complete a job.

Some drive tools are configured such that, if an operator wishes to use the drive tool to install a fastener into a floor, the operator must get on the floor, on his or her knees, in order to use the drive tool to drive the fastener into the floor. Of course, getting on one's knees every time one installs a fastener in a floor can be uncomfortable and tedious. This is especially true in the case where a large number of fasteners must be installed over a large floor surface area.

Other drive tools, such as those which are disclosed in U.S. Pat. Nos. 3,960,191; 4,236,555; and 5,897,045 are configured such that an operator can remain standing while using the drive tool to install fasteners into a floor. Such drive tools are essentially extended tools connected to a power drill or to some other driving source. Typically, the drive tool is configured such that fasteners are automatically fed to the end of the drive tool. This provides that the operator can use the drive tool to install a plurality of fasteners without having to bend over each time to place a fastener at the end of the tool. Unfortunately, such drive tools are typically relatively heavy and the operator must apply substantial upper-body effort to apply the necessary axial force to the drive tool to install a fastener. Therefore, using such a drive tool, especially if an operator must use the drive tool everyday for extended periods of time, can be tiring.

### OBJECTS AND SUMMARY

Accordingly, it is an object of an embodiment of the present invention to provide a drive tool which does not require any upper-body force from an operator to install a fastener.

Another object of an embodiment of the present invention is to provide a drive tool configured such that an operator can easily use his or her own body weight to apply an axial load during a drilling operation.

Briefly, and in accordance with one or more of the foregoing objects, an embodiment of the present invention provides a drive tool having a top portion which is engageable with a drive source, such as a drill, and a lower portion which is engageable with a fastener. The drive tool includes springs which are configured to urge the lower portion and upper portion of the tool away from each other (i.e. relative movement) and provide that a generally axial force is applied to the fastener engaged with the lower portion of the tool. As a result, the operator does not need to apply any upper-body axial force to the drive tool to install the fastener.

Preferably, the lower portion of the drive tool includes one or more foot pads on which an operator may stand, and the spring(s) become compressed when the operator stands on the foot pad(s). As a result of the spring(s) trying to expand under compression, a generally axial force is applied to the fastener engaged with the lower portion of the tool, thereby reducing the amount of upper-body axial force an operator must apply to the drive tool to install the fastener. Hence, the operator can use his or her own body weight to apply an axial load during a drilling operation, and need not use any upper-body force.

### BRIEF DESCRIPTION OF THE DRAWINGS

The organization and manner of the structure and function of the invention, together with further objects and advantages thereof, may be understood by reference to the following description taken in connection with the accompanying drawings, wherein:

FIG. 1 is a perspective view of a drive tool in accordance with an embodiment of the present invention, showing (in phantom) a drill engaged with the drive tool;

FIG. 2 is a front elevational view of the drive tool illustrated in FIG. 1;

FIG. 3 is a front elevational view similar to FIG. 2, but omitting portions of the drive tool for clarity;

FIG. 4 is a side elevational view of the drive tool illustrated in FIGS. 1 and 2, showing (in phantom) the drill engaged with the drive tool;

FIG. 5 is a side elevational view similar to FIG. 4, but omitting portions of the drive tool for clarity;

FIG. 6 is a top plan view of a foot pad of the drive tool illustrated in FIGS. 1-5;

FIG. 7 is a cross-sectional view of the drive tool illustrated in FIGS. 1-5, taken along line 7-7 of FIG. 2, showing (in phantom) a drill engaged with the drive tool;

FIG. 8 is a cross-sectional view of the drive tool illustrated in FIGS. 1-5, taken along line 8-8 of FIG. 2;

FIG. 9 is a cross-sectional view of the drive tool illustrated in FIGS. 1-5, taken along line 9-9 of FIG. 2;

FIG. 10 is a cross-sectional view of the drive tool illustrated in FIGS. 1-5, taken along line 10-10 of FIG. 2;

FIG. 11 is a front elevational view of a drive tool in accordance with another embodiment of the present invention; and

FIG. 12 is a side elevational view of the drive tool illustrated in FIG. 11, showing (in phantom) a drill engaged with the drive tool.

### DESCRIPTION

While the present invention may be susceptible to embodiment in different forms, there are shown in the drawings, and herein will be described in detail, embodiments of the invention with the understanding that the present description is to be considered an exemplification of the principles of the invention and is not intended to limit the invention to that as illustrated and described herein.

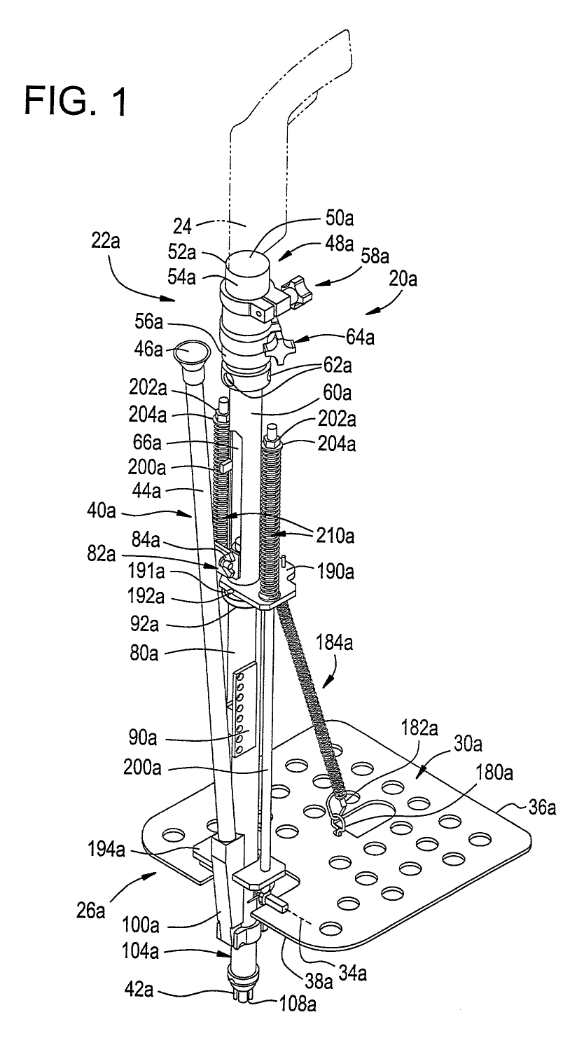

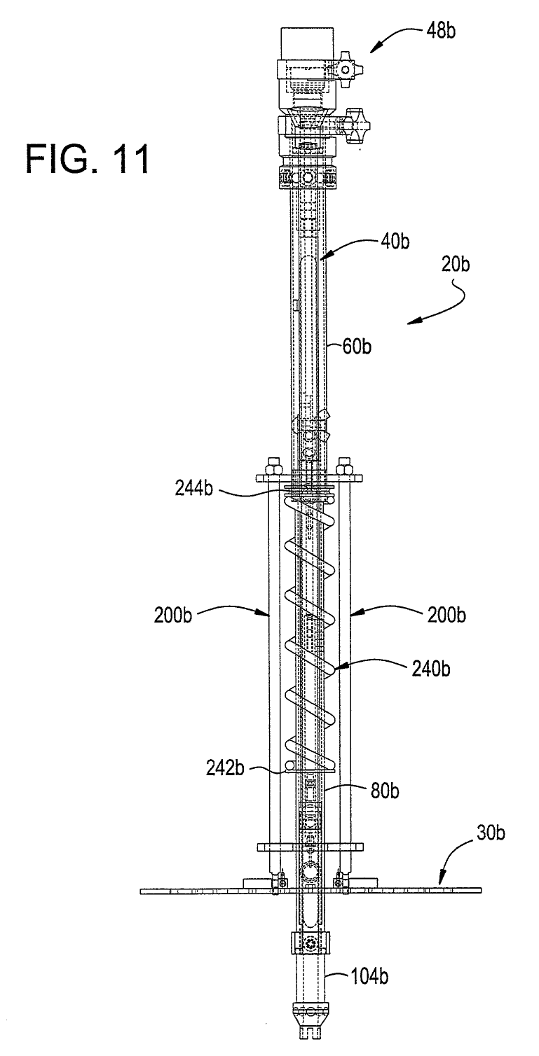

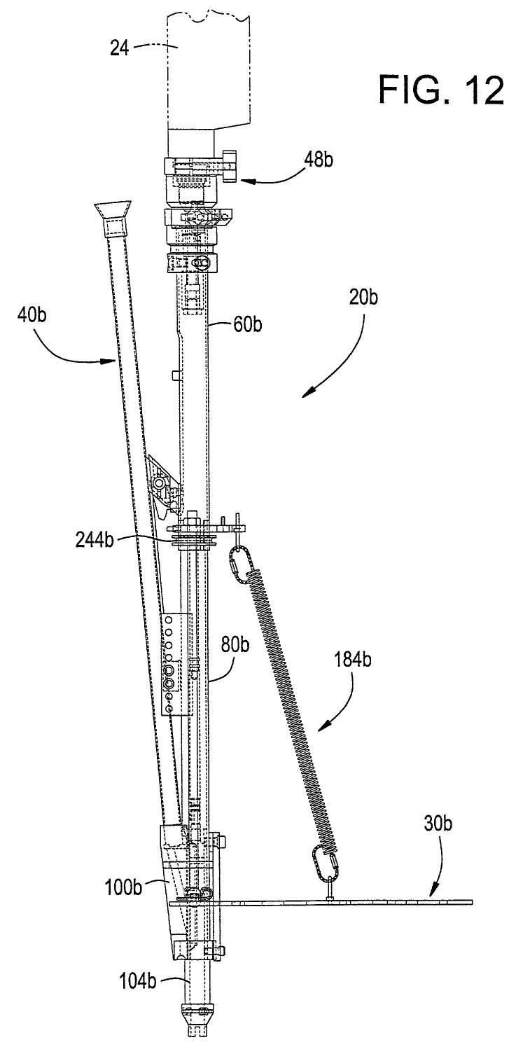

Shown in the FIGURES are two drive tools 20a and 20b each of which is in accordance an embodiment with the present invention. Specifically, FIGS. 1, 2 and 4 illustrate a drive tool 20a in accordance with a first embodiment of the present invention, and FIGS. 11 and 12 illustrate a drive tool 20b in accordance with a second embodiment of the present invention. Each drive tool 20a, 20b is configured such that an operator can use the drive tool 20a, 20b to drive a fastener into a work piece without having to use a substantial amount of upper-body force.

The drive tool 20a shown in FIGS. 1, 2 and 4 will be described first, and then the drive tool 20b shown in FIGS. 11 and 12 will be described. In the following description, like reference numerals are used to identify like parts, and different alphabetic suffixes (i.e., “a” and “b”) are used for each of the different embodiments. At times, a detailed description of a part is omitted with the understanding that one may review the description relating to a corresponding part of the other embodiment.

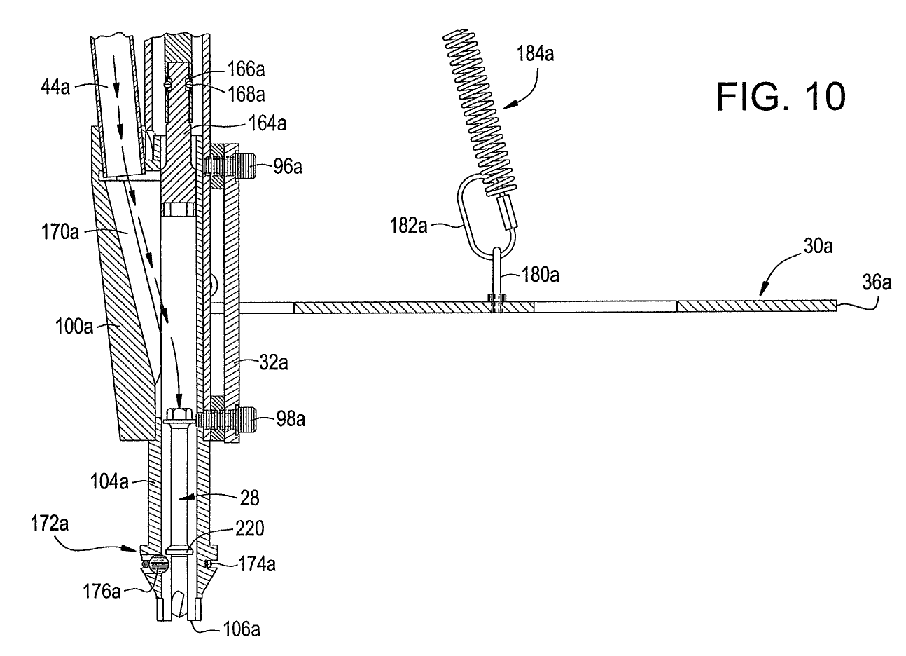

The drive tool 20a shown in FIGS. 1, 2 and 4 includes an upper end 22a which is configured for engagement with a drive source 24 (see FIGS. 1, 4 and 7, wherein the drive source 24 is shown in phantom), such as with a power drill, and includes a lower end 26a which is configured to receive a fastener 28 (see FIG. 10). The drive tool 20a provides that an operator can engage the drive source 24 with the upper end 22a of the drive tool 20a, and operate the drive source 24 to cause the drive tool 20a to drive the fastener 28 into a work piece, without the operator having to use a substantial amount of upper-body force.

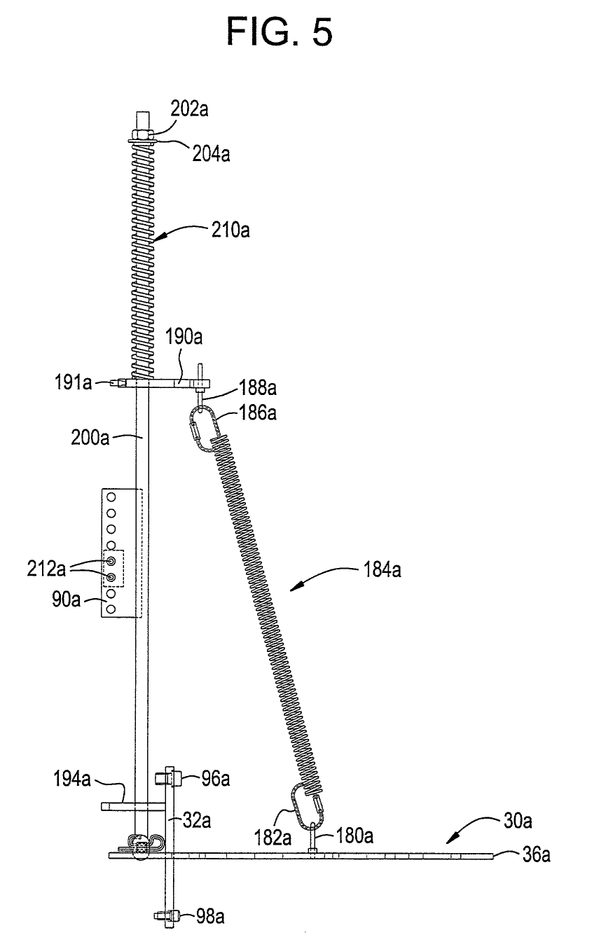

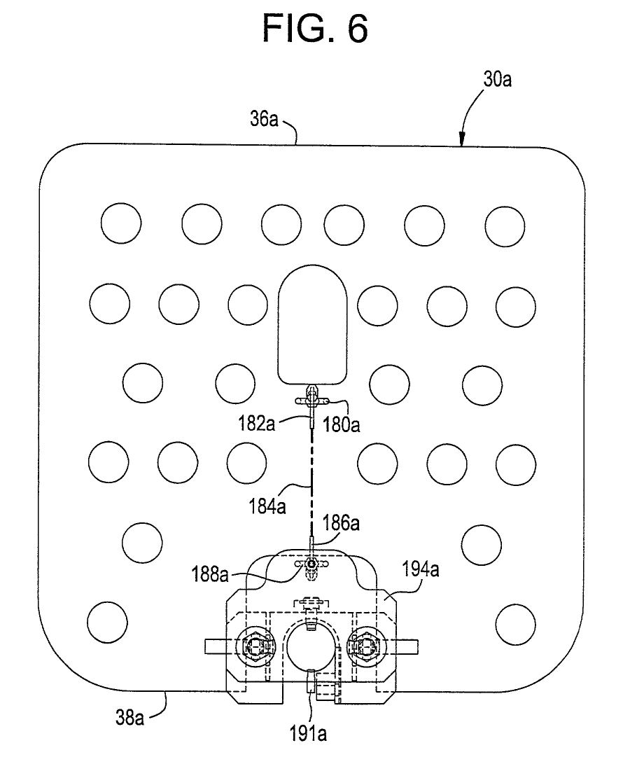

As shown in FIGS. 1-5 and 10, the drive tool 20a preferably includes a foot pad 30a on which the operator can stand when operating the drive tool 20a (the foot pad 30a is shown generally isolated in FIG. 6). As a result, the operator can use his or her own body weight to apply an axial load to the fastener 28 while using the drive tool 20a to drive the fastener 28 into a work piece.

Preferably, the foot pad 30a extends from a bracket 32a which is attached to the lower end 26a of the drive tool 20a, and the foot pad 30a is pivotable about an axis 34a (see FIG. 1). Preferably, the foot pad 30a is pivotable such that when an operator stands on the foot pad 30a, an outer edge 36a of the foot pad 30a pivots downward (i.e., the foot pad 30a pivots about axis 34a) and contacts the floor. Incidentally, the other edge 38a of the foot pad 30a drops down close to the floor, but preferably does not touch the floor. This arrangement of having the axis 34a down by the end 42a of the tool 20a, allows the tool 20a to have a fulcrum point close to the floor. This results in the tool 20a having, effectively, a maximum amount of freedom to pivot in any direction. Pivoting is important to allow the operator to accommodate an uneven floor surface or other obstruction. In addition, the foot pad 30a provides that an operator can place both feet on the foot pad 30a, thereby maintaining his or her balance, and allows the operator to step one foot at a time on the foot pad 30a.

The foot pad 30a may also be configured such that the foot pad 30a can be pivoted upward into a non-operating position, and can be pivoted downward into an operating position (which is shown in the FIGURES). As will be described more fully later herein, preferably the foot pad 30a is spring-connected to a higher portion of the drive tool 20a so that the foot pad 30a does not tend to drop down between installations.

Although not shown, the drive tool 20a may include handles extending outwardly from the upper end 22a of the drive tool 20a. The handles would allow an operator to readily grip the drive tool 20a during use. The handles would also facilitate transportation of the drive tool 20a, such as the transportation of the drive tool 20a at a given job site, as well as the transportation of the drive tool 20a from one job site to another.

Preferably, as shown in FIGS. 1, 2, 4 and 7-10, an automatic fastener feeding mechanism 40a is in communication with the lower end 26a of the drive tool 20a. The automatic fastener feeding mechanism 40a is preferably configured to automatically feed fasteners 28 to the end 42a of the drive tool 20a so that an operator need not bend over and engage a fastener with the end 42a of the drive tool 20a each time the drive tool 20a is to be used to drive a fastener 28 into a work piece.

As shown, the automatic fastener feeding mechanism 40a may comprise a gravity feed tube 44a that includes a funnel end piece 46a to facilitate the deposit of fasteners 28 into the feed tube 44a. As such, the feed tube 44a essentially functions as a conduit between the standing operator and the end 42a of the drive tool 20a. Alternatively, the automatic fastener feeding mechanism 40a may comprise a magazine feed tube or a cartridge feeder.

As shown in FIGS. 1, 2, 4 and 7, the upper end 22a of the drive tool 20a includes a housing 48a. The housing 48a includes an opening 50a at an end 52a thereof for receiving the drive source 24 (see FIGS. 1, 4 and 7), such as for receiving the driven, rotating portion of a power drill. The housing 48a may include an upper portion 54a which provides the opening 50a, and a lower portion 56a to which the upper portion 54a is secured (said securement including adjustable clamp 58a—see FIGS. 1, 2 and 4). Alternatively, the housing 48a can be provided as a single piece, effectively incorporating upper portion 54a and lower portion 56a.

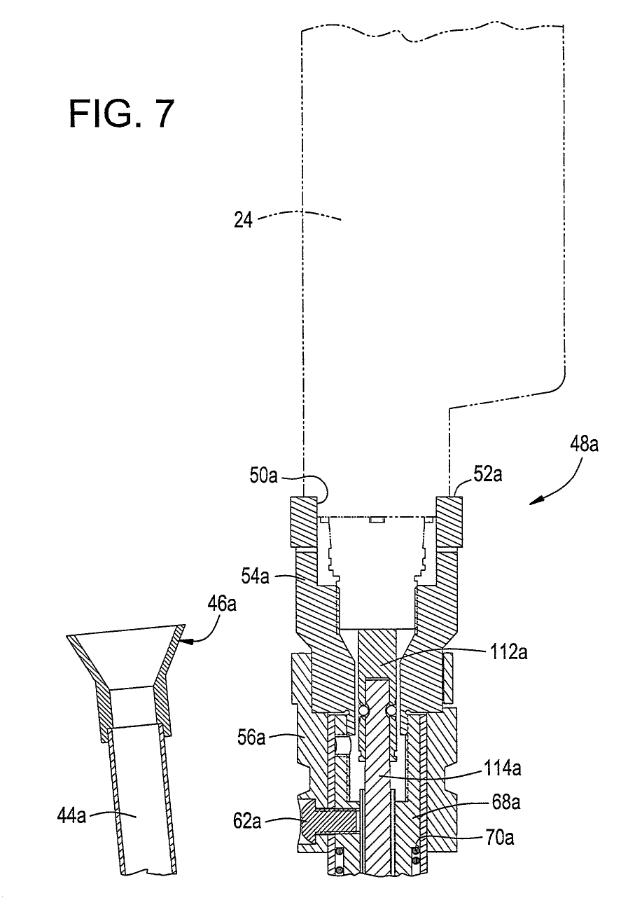

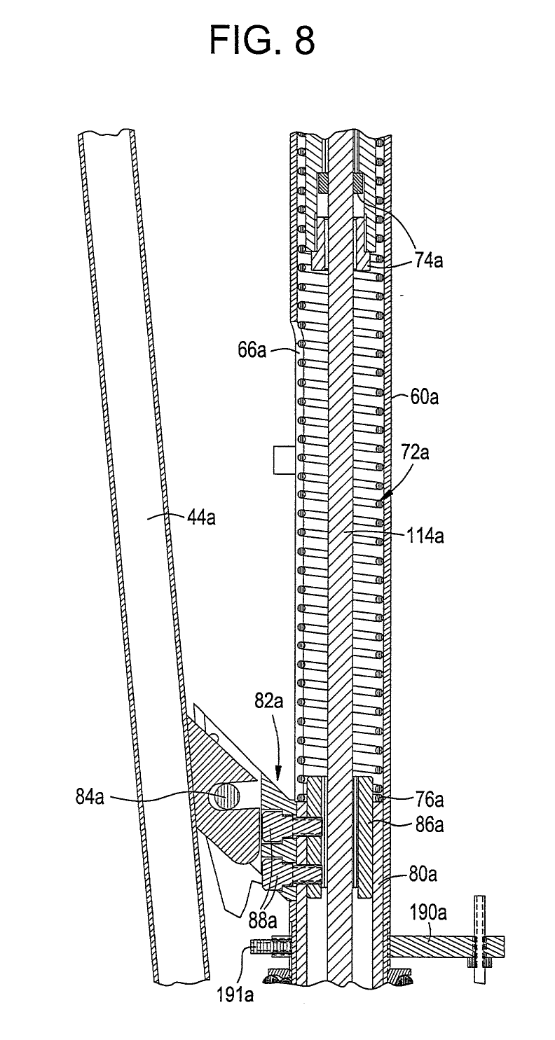

As shown in FIGS. 1, 2, 4 and 7, the lower portion 56a of the housing 48a is attached to an upper tube 60a (via securing members 62a and adjustable clamp 64a), and the upper tube 60a includes a slot 66a (see FIGS. 1 and 8). As shown in FIG. 7, a collar 68a is secured to the lower portion 56a of the housing 48a (via securing members 62a) and engages an end 70a of a spring 72a disposed in the upper tube 60a. As shown in FIG. 8, collar and guide structure 74a is preferably disposed on the collar 68a, and the spring 72a extends through the upper tube 60a and engages a top surface 76a of a lower tube 80a. Specifically, 74A in FIG. 8 points to two different components. The upper component is a collar that is pressed onto the shaft 114a, and does not move. The lower component is a “guide” that slides along the shaft 114a but has threads on its outside diameter and is threaded onto the collar 68a. The spring 72a serves to return the drive tool 20a to its starting position in use.

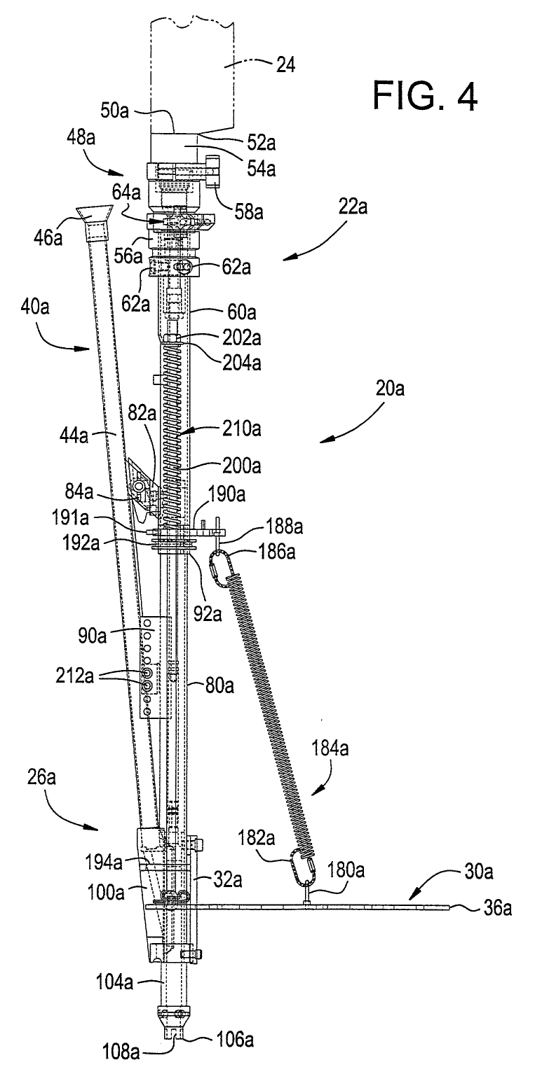

As shown in FIGS. 1, 4 and 7, a stop bracket 82a is attached to the feed tube 44a (via wing nut 84a), and is secured to the lower tube 80a and a bottom tube cap 86a (via securing members 88a). Preferably, as shown in FIGS. 1 and 4, the feed tube 44a is also connected to the lower tube 80a via an adjustable bracket 90a. The adjustable bracket 90a may provide that the length of travel of the drive tool 20a (during operation) can be adjusted. Alternatively, a torque clutch (i.e., a slip clutch) can be provided.

As shown in FIGS. 1, 2, 4 and 10, the lower tube 80a extends from an opening 92a in the bottom end 94a of the upper tube 60a such that the lower tube 80a essentially telescopes from the opening 92a. Specifically, the lower tube 80a extends from the opening 92a in the upper tube 60a and is moveable relative to the upper tube 60a during a drilling operation. This will be described more fully herein.

As shown in FIG. 10, the foot pad bracket 32a is secured to the bottom of the lower tube 80a via securing member 96a and button head screw 98a. As shown in FIGS. 1, 4 and 10, a shuttle 100a effectively connects the lower end of the gravity feed tube 44a to the lower tube 80a. Preferably, the button head screw 98a connects to a nosepiece or end piece 104a, and provides that the end piece 104a can be relatively easily removed from the lower tube 80a and replaced. The end piece 104a ultimately receives the fasteners from the feed tube 44a (see FIG. 10), and the fasteners 28 exit an opening 106a in the end 42a of the end piece 104a when they are installed using the drive tool 20a. As shown (see, for example, FIGS. 1, 2 and 4), preferably the opening 106a includes four slots 108a which allow “chip relief” (i.e., allow chips to escape from under the drill tool 20a during drilling).

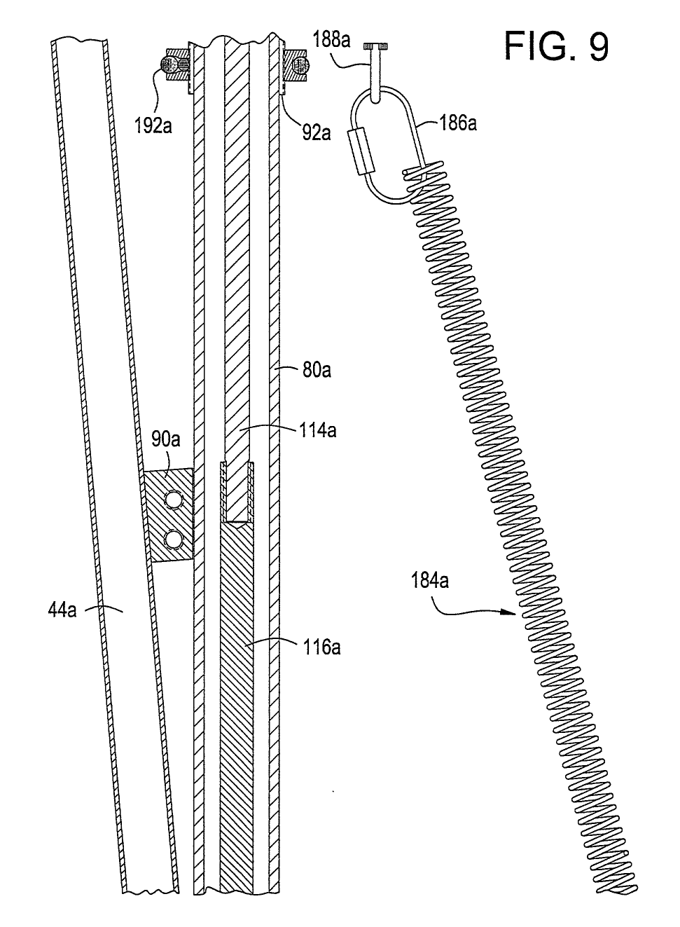

As discussed above, the housing 48a at the top of the drive tool 20a has an opening 50a configured for receiving a drive source 24, such as the rotating, driven end of a power drill. As shown in FIG. 7, the drive source 24 engages an adaptor 112a in the housing 48a, and the adaptor 112a engages a shaft 114a that extends along a substantial length of the drive tool 20a. The shaft 114a extends from the adaptor 112a, through the collar 68a, through the spring 72a, through the bottom tube cap 86a, and is engaged, at its end, with an extension 116a. As shown in FIGS. 9 and 10, the extension 116a engages a drive bit 164a or nut driver in the end piece 104a, and the drive bit 164a engages the fastener 28 to be installed using the drive tool 20a. Preferably, a retaining ring 166a and ball bearing 168a retain the drive bit 164a with the end of the shaft 114a. A pair of set screws may also be provided to retain the drive bit 164a to the end of the shaft 114a. Preferably, the engagement is such that the drive 164a bit can be easily replaced. Although the shaft 114a is shown engaged with an extension 116a, the extension 116a could be omitted, in such case the shaft 114a would be longer than depicted in the FIGURES and would engage directly with the drive bit 164a.

As shown in FIG. 10, the shuttle 100a provides a passageway 170a extending between the gravity feed tube 44a and the end piece 104a, and the passageway 170a provides that a fastener 28 can travel from the gravity feed tube 44a to the end piece 104a. Preferably, a fastener retaining structure 172a is provided in the end piece 104a for engagement with the fastener 28 when the fastener 28 is disposed in the end piece 104a. Specifically, the fastener retaining structure 172a may comprise an o-ring 174a and steel ball 176a. Preferably, the fastener retaining structure 172a allows any unwanted fasteners in the end piece 104a to be easily removed.

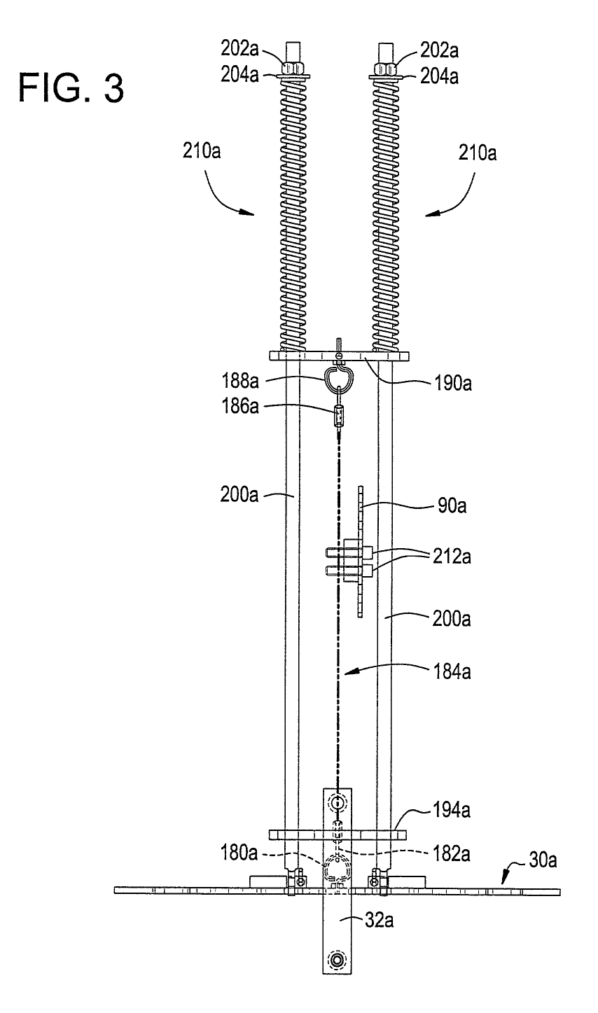

As shown in FIGS. 1, 3, 4, 5, 9 and 10, the foot pad 30a is preferably spring-connected to the upper tube 60a. Specifically, preferably a ring 180a is connected to the foot pad 30a, and the ring 180a engaged with a removable ring 182a that is engaged with a spring 184a (the spring 184a is represented by a dashed line in FIGS. 3 and 6). The opposite end of the spring 184a is engaged with another removable ring 186a that is engaged with a ring 188a that is secured to an upper bracket 190a on the upper tube 60a. The upper bracket 190a is threaded to the upper tube 60a and is further retained thereon by a set screw 191a. Additionally, nut 192a effectively retains the upper bracket 190a on the upper tube 60a. The fact that the foot pad 30a is spring-connected to the bracket 190a serves the purpose of generally preventing the foot pad 30a from simply dropping down when the drill tool 20a is lifted as it is positioned for the next fastener. Otherwise, the drive tool 20a would be relatively difficult to maneuver between fastenings.

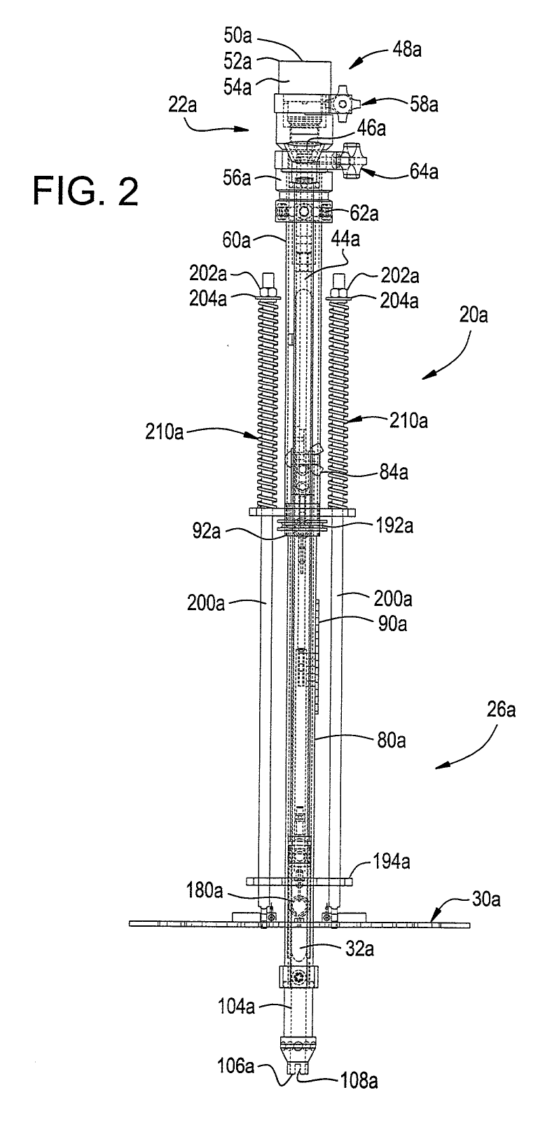

As shown in FIGS. 1 and 2, a lower bracket 194a is secured to the lower tube 80a, and a pair of rods 200a—one on each side of the drive tool 20a—are attached to the lower bracket 194a. The rods 200a are generally parallel to the upper and lower tubes, 60a and 80a, and extend upward, and through the upper bracket 190a to which the spring 184a is effectively attached. Preferably, each of the rods 200a is threaded or at least includes a threaded portion such that a nut 202a and washer 204a are engaged with each rod 200a. As shown in FIGS. 1-5, each rod 200a carries a spring 210a, and each spring 210a is disposed between the upper bracket 190a and the washer 204a on the rod 200a. Preferably, the nuts 202a can be adjusted along the lengths of the rods 200a, and this provides that the initial compression of the springs 210a can be adjusted.

Because the rods 200a are effectively attached to the lower tube 80a (via lower bracket 194a), when an operator places the end piece 104a of the drive tool 20a onto the floor and steps on the foot pad 30a, his or her body weight forces the rods 200a to travel downward. As the rods 200a travel downward, the washers 204a compress the springs 210a, and the springs 210a exert a force against the upper bracket 190a. Since the upper bracket 190a is secured to the upper tube 60a, this compression pushes the upper tube 60a downward and applies an end load to the fastener. Hence, an operator can install a fastener using his or her body weight (by applying same to the foot pad 30a) without having to employ a substantial amount of upper-body axial force.

Typically, a fastener will require a given end load in order to successfully drill through and form threads. Preferably, the load/deflection design of the springs 210a is such that the springs 210a exert the required amount of load generally uniformly throughout the length of travel needed for the drilling sequence. The springs 210a then preferably maintain sufficient load (albeit preferably somewhat less) after the drilling sequence to allow the thread forming sequence to occur.

Preferably, the drive tool 20a is configured such that the length of travel, during operation, of the drive tool 20a is adjustable to accommodate different length screws. This can be performed by changing the position of screws 212a (see, for example, FIG. 3) that go into the bracket 90a secured to the feed tube 44a. Preferably, the adjustment can be made in 0.5 inch increments. Additional fine tuning can be effected by turning nut 192a to which the upper bracket 190a is affixed. This additional fine tuning is needed in case it is required to manually disengage the socket from the head of the fastener.

To use the drive tool 20a to drive a fastener 28 into a work piece, an operator engages a drive source 24 with the end 52a of the housing 48a. Then, the operator drops one or more fasteners 28 into the gravity feed tube 44a. Preferably, the operator drops a fastener 28 having a flange thereon 220 as shown in FIG. 10. Specifically, the fastener 28 may be a self-drilling fastener, such as a fastener consistent with that which is shown and described in U.S. Pat. No. 5,605,423, which is incorporated herein in its entirety by reference.

The fastener 28 moves from the gravity feed tube 44a, through the passageway 170a in the shuttle 100a, and into the end piece 104a, to the position shown in FIG. 10. As shown, preferably the fastener 28 drops into a position such that the lower flange 220 on the fastener 28 contacts the steel ball 176a in the end piece 104a. The steel ball 176a prevents the fastener 28 from exiting prematurely from the opening 106a of the end piece 104a, and positions the fastener for engagement by the socket and prevents the fastener from sticking out of the nosepiece prematurely.

Thereafter, the operator manipulates the drive tool 20a such that the end of the fastener 28 is disposed against the work piece, at the location at which the operator wants to install the fastener 28. Then, the operator steps on the foot pad 30a and operates the drive source 24 to cause the adaptor 112a, shaft 114a and drive bit 164a to rotate. When the operator stands on the foot pad 30a, the outer edge 36a of the foot pad 30a pivots downward (i.e., the foot pad 30a pivots about axis 34a) and contacts the floor. The other edge 38a of the foot pad 30a preferably drops down close to the floor, but preferably does not touch the floor. Because the rods 200a are effectively attached to the lower tube 80a (via lower bracket 194a), when an operator places the end piece 104a of the drive tool 20a onto the floor and steps on the foot pad 30a, his or her body weight forces the rods 200a to travel downward. As the rods 200a travel downward, the washers 204a compress the springs 210a, and the springs 210a exert a force against the upper bracket 190a. Since the upper bracket 190a is secured to the upper tube 60a, this compression pushes the upper tube 60a downward and the upper tube 60a telescopes downwardly over the lower tube 80a. The combination of the spring-loaded force and the operator force on the foot pad 30a of the drive tool 20a causes the drive tool 20a to apply an end load to the fastener, thereby forcing the fastener 28 beyond the steel ball 176a in the end piece 104a, and driving the fastener 28 into the work piece. Hence, an operator can use the drive tool 20a to install a fastener using his or her body weight (on the foot pad 30a), without having to employ a substantial amount of upper-body axial force.

While the fastener 28 is being driven into the work piece, the compression of the springs 210a imparts an axially directed force along the shaft 114a. Hence, the structure provides an axial load assist mechanism that effectively reduces the amount of upper-body axial force an operator must apply to the drive tool 20a. Hence, the operator can use the drive tool 20a to install fasteners more quickly and with less effort. Preferably, the springs 210a create a generally constant axial spring load throughout the drilling and thread forming process. Additionally, during drilling and tapping, preferably a constant force is kept on the fastener. Preferably, the springs 210a apply a constant axial load resulting in fast drill and tapping times.

Once the fastener has been driven into the work piece, the operator can step off the foot pad 30a and the drive tool 20a will return to the starting position (due to the force of the spring 72a). At this point, another fastener 28 is fed to the end piece 104a from the gravity feed tube 44a.

The drive tool 20b shown in FIGS. 11-12 is similar to the drive tool 20a shown in FIGS. 1, 2 and 4, and hence, like drive tool 20a, includes, among other parts, a foot pad 30b, an automatic fastener feeding mechanism 40b, a housing 48b, an upper tube 60b, a lower tube 80b, a shuttle 100b, an end piece 104b and a spring 184b. In fact, the only major difference between the drive tool 20b shown in FIGS. 10-12 and the drive tool 20a shown in FIGS. 1, 2 and 4 is that instead of including springs on rods on each side of the drive tool, as is provided on drive tool 20a, the drive tool 20b shown in FIGS. 11-12 includes a single spring 240b which is retained on the lower tube 80b, between a ring 242b and an adjustable nut 244b. Ring 242b is adjustable up or down, and serves as a stop for the spring 240b. Operation of the drive tool 20b is effectively the same as operation of the drive tool 20a already described except that when an operator steps on the foot pad 30b, the single spring 240b compresses between the ring 242b and nut 244b to provide an axial assist mechanism that obviates the need for the operator to employ a substantial amount of upper-body force to effect a drilling operation. As shown, the drive tool 20b does include rods 200b on each side of the drive tool 20b, but, unlike the rods 200a of drive tool 20a, do not carry springs which compress when an operator steps on the foot pad 30b.

Although not shown in the FIGURES, either one of the drive tools 20a, 20b can be provided with wheels for facilitating the transportation of the tool—both between fastenings at a given site and from one site to another.

While embodiments of the present invention are shown and described, it is envisioned that those skilled in the art may devise various modifications without departing from the spirit and scope of the appended claims.

What is claimed is:

1. A drive tool engageable with a drive source and a fastener, said drive tool comprising: a top portion which is engageable with the drive source; a lower portion which is engageable with the fastener, said drive tool including at least one spring which is configured to urge the lower portion and upper portion of the tool away from each other and at least one spring which is configured to provide that a generally axial force is applied to the fastener which is engaged with the lower portion of the tool.

2. A drive tool as recited in claim 1, wherein said drive tool is configured such that an operator need not apply any upper-body axial force to the drive tool to install the fastener.

3. A drive tool as recited in claim 1, wherein said lower portion of the drive tool includes at least one foot pad.

4. A drive tool as recited in claim 3, wherein said at least one foot pad is pivotable.

5. A drive tool as recited in claim 3, wherein said at least one foot pad is spring-connected to a portion of the drive tool.

6. A drive tool as recited in claim 3, wherein the drive tool is configured such that said at least one spring compresses when an operator stands on the at least one foot pad.

7. A drive tool as recited in claim 1, said drive tool configured such that compression of said at least one spring results in a generally axial force being applied to the fastener engaged with the lower portion of the tool.

8. A drive tool as recited in claim 1, further comprising a handle on the top portion of the drive tool and a foot pad on the lower portion of the tool.

9. A drive tool as recited in claim 1, further comprising an automatic fastener feeding mechanism in communication with the lower portion of the drive tool and configured to feed fasteners to the lower portion of the drive tool.

10. A drive tool as recited in claim 9, said automatic fastener feeding mechanism comprising a gravity feed tube which includes a funnel end piece.

11. A drive tool as recited in claim 1, further comprising a spring generally contained in the drive tool.

12. A drive tool as recited in claim 1, further comprising an adjustable bracket on the drive tool, said adjustable bracket configured to provide that a length of travel of the drive tool during use is adjustable.

13. A drive tool as recited in claim 1, further comprising an end piece having at least one chip relief slot.

14. A drive tool as recited in claim 1, further comprising an end piece and fastener retaining structure in the end piece.

15. A drive tool as recited in claim 1, further comprising at least one rod, said at least one spring disposed on said rod.

16. A drive tool as recited in claim 1, further comprising a pair of rods, said at least one spring comprising a spring disposed on each rod.

17. A drive tool as recited in claim 1, further comprising a lower bracket engaged with the lower portion of the drive tool, an upper bracket engaged with the upper portion of the drive tool, at least one rod extending from said lower bracket and through said upper bracket to an end of said rod, said at least one spring disposed on said rod generally between said upper bracket and said end of said rod.

18. A drive tool as recited in claim 17, wherein said lower portion of the drive tool includes at least one foot pad, wherein said at least one foot pad is spring-connected to said upper bracket.

19. A drive tool as recited in claim 1, further comprising a lower bracket engaged with the lower portion of the drive tool, an upper bracket engaged with the upper portion of the drive tool, a pair of rods extending from said lower bracket and through said upper bracket, said at least one spring comprising a spring disposed on each rod, generally between said upper bracket and a respective end of said rod.

20. A drive tool as recited in claim 19, wherein said lower portion of the drive tool includes at least one foot pad, wherein said at least one foot pad is spring-connected to said upper bracket.

21. A drive tool as recited in claim 1, further comprising a tube, a ring on said tube and a nut on said tub, a lower bracket engaged with the lower portion of the drive tool, an upper bracket engaged with the upper portion of the drive tool, a pair of rods extending from said lower bracket and through said upper bracket, said at least one spring disposed on said tube between said ring and said nut.
